(19) United States
(12) Patent Application Publication
(10) Pub. No.: US 2014/0334260 A1
(43) Pub. Date: Nov. 13, 2014

(54) Neural Network Signal Processing of Microseismic Events

(71) Applicant: SCHLUMBERGER TECHNOLOGY CORPORATION, Sugar Land, TX (US)

(72) Inventors: Chung Chang, Wilton, CT (US); Henri-Pierre Valero, Yokohama-shi (JP); Richard T. Coates, Katy, TX (US)

(73) Assignee: Schlumberger Technology Corporation, Sugar Land, TX (US)

(21) Appl. No.: 13/891,183

(22) Filed: May 9, 2013

(51) Int. Cl. G01V 1/30

(52) U.S. Cl. CPC G01V 1/305; G01V 1/40
USPC 367/27

(57) ABSTRACT

Systems, apparatuses and methods for neural network signal processing of microseismic events. A series of sensors are disposable in at least one first well positioned about a second well disposed in a subterranean formation. The series of sensors obtain a data signal measurement including noise events and microseismic acoustic emission events. A processor includes a first neural network. The processor may remove the noise events from the data signal measurement and determine with the first neural network an arrival time for each microseismic acoustic emission event. An interface can output the arrival time for each microseismic acoustic emission event.

### BACKGROUND

The present disclosure relates to seismic data processing. More specifically, the present disclosure relates to neural network based mapping of extensions of hydraulic fracturing events during fluid injection and well production. Seismic data processing has long been associated with the exploration and development of subterranean resources such as hydrocarbon reservoirs.

Hydraulic fracturing can be used to increase conductivity of a subterranean formation for recovery or production of hydrocarbons and to permit injection of fluids into subterranean formation or into injection wells. In a typical hydraulic fracturing operation, a fracturing fluid is injected under pressure into the formation through a wellbore. Particulate material known as proppant may be added to the fracturing fluid and deposited in the fracture as the fracture is formed to hold open the fracture after hydraulic fracturing pressure is relaxed.

Microseismic waves are generated at the tip of propagating hydraulic fractures that can, if monitored, provide information about a front of the progressing fractures while injecting fluid into the reservoir to aid in avoiding environmental and production problems. Monitoring microseismic waves generated by propagating hydraulic fractures may present a challenge since the signal-to-noise ratio between microseismic events and background noise can be small, and acquisition systems used for such monitoring may have to record a huge amount of data.

Some hydraulic fracturing monitoring techniques are described in: R. D. Barree, “Application of pre-frac injection/falloff tests in fissured reservoirs field examples,” SPE paper 39932, presented at the 1998 SPE Rocky Mountain Regional Conference, Denver, Apr. 5-8, 1998; C. L. Cipolla and C. A. Wright, “State-of-the-art in hydraulic fracture diagnostics,” SPE paper 64434, presented at the SPE Asia Pacific Oil and Gas Conference and Exhibition held in Brisbane, Australia, October 1618, 2000; C. A. Wright et al., “Downhole tiltmeter fracture mapping: A new tool for directly measuring hydraulic fracture dimensions,” SPE paper 49193, presented at 1998 SPE Annual Technical Conference, New Orleans, 1998; C. A. Wright et al., “Surface tiltmeter fracture mapping reaches new depths 10,000 feet, and beyond,” SPE paper 39919, presented at the 1998 SPE Rocky Mountain Regional Conference, Denver, Apr. 5-8, 1998; N. R. Warpinski et al., “Mapping hydraulic fracture growth and geometry using microseismic events detected by a wireline retrievable accelerometer array,” SPE paper 40014, presented at the 1998 SPE Gas Technology Symposium in Calgary, Canada, Mar. 15-16, 1998; R. L. Johnson Jr. and R. A. Woodroof Jr., “The Application of Hydraulic Fracturing Models in Conjunction with Tracer Surveys to Characterize and Optimize Fracture Treatments in the Brushy Canyon Formation, Southeastern New Mexico,” SPE paper 36470, presented at the 1996 Annual Technical Conference and Exhibition, Denver, Oct. 6-9, 1996; J. T. Rutledge and W. S. Phillips, “Hydraulic Stimulation of Natural Fractures as Revealed by Induced Microearthquakes, Carthage Cotton Valley Gas Field, East Texas,” Geophysics, 68:441-452, 2003; and N. R. Warpinski, S. L. Wolhart, and C. A. Wright, “Analysis and Prediction of Microseismicity Induced by Hydraulic Fracturing,” SPE Journal, pages 24-33, March 2004.

### SUMMARY

In at least one aspect, the disclosure relates to systems, apparatuses, and methods for neural network signal processing of microseismic events.

In at least one aspect, the disclosure relates to a method for neural network signal processing of microseismic events. The method can include disposing a series of sensors in at least a first well disposed adjacent to a second well. The method can also include obtaining a data signal measurement including noise events and microseismic acoustic emission events with the series of sensors. The method can include removing the noise events from the data signal measurement. The method can include determining with a first neural network an arrival time for each microseismic acoustic emission event.

In at least one aspect, the disclosure relates to a system for neural network signal processing of microseismic events. The system can include a series of sensors disposable in at least one first well positioned about a second well disposed in a subterranean formation. The series of sensors may obtain a data signal measurement including noise events and one or more microseismic acoustic emission events. The system can include a processor including a first neural network. The processor may remove the noise events from the data signal measurement and determine with the first neural network an arrival time for each microseismic acoustic emission event. The system can also include an interface that outputs the arrival time for each microseismic acoustic emission event.

In at least one aspect, the disclosure relates to a computer program product, including a computer usable medium with a computer readable program code embodied therein. The computer readable program code processes microseismic signal events, in that execution of the computer readable program code by one or more processors of a computer system causes the one or more processors to receive a data signal measurement of noise events and microseismic acoustic emission events from a series of sensors disposed in a first well. Execution of the computer readable program code may also cause the one or more processors to remove the noise events from the data signal measurement. Execution of the computer readable program code may also cause the one or more processors to determine with a first neural network an arrival time for each microseismic acoustic emission event.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of systems, apparatuses, and methods for neural network signal processing of microseismic events are described with reference to the following figures Like numbers are used throughout the figures to reference like features and components.

FIG. 1 shows an example wellsite with an apparatus for performing and monitoring hydraulic fracturing using microseismic data.

FIG. 2 illustrates microseismic wave generation associated with hydraulic fracturing in greater detail.

FIG. 3 shows an example wellsite with a plurality of injection wells and a spiral monitoring well having therein disposed an apparatus for performing and monitoring hydraulic fracturing using microseismic data.

FIG. 4 shows a flowchart for a method for neural network signal processing of microseismic events.

FIG. 5 shows a block diagram of a computer system by which methods disclosed herein can be implemented.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

Methods, systems and apparatuses presented herein are directed to signal processing to filter and automatically classify recorded microseismic events with a neural network based mapping technique. The signal processing may begin with filtering out background noise of a recorded signal. In an embodiment, the filtering of background noise may be performed with a wavelet based method, for example, as discussed further herein, or other suitable processing methods. The signal processing may also include identifying events present on various recorded waveforms (i.e., waveforms recorded on various channels). In an embodiment, the recorded signal has a relatively small amplitude due to the fact that the signal is based on microseismic events; thus, a high order statistic method can be employed to detect the events. A method of the present disclosure includes detecting small events in presence of colored noise, instead of white Gaussian noise. Because the number of events recorded can be vast, on the order of several thousands, a neural network based mapping can be applied to analyze and classify the recorded events in an automatic manner. In an embodiment, a plurality of monitoring wells, for example, two or more monitoring wells, may be used to record the data to train the neural network. In an embodiment, a monitoring well may be placed as a single spiral well about an injecting well.

A conventional method for monitoring acoustic emission (AE) events is to position an injection well and a monitoring well equipped with an array of sensors to listen. Since a time origin of each AE event is unknown, the formation speed information and the arrival time difference between different receivers can be used to invert for the location of each source event. Three component geophones can be used to narrow the direction of incoming AE waves. However, the acoustic emission is most accurately located if it occurs between two receivers, because the arrival time moves earlier in one receiver as the position of the event moving closer to it the corresponding arrival time moves later in time for the opposite receiver.

In a one dimensional example, the difference in the arriving time between two detectors with an AE event occurring in between the two detectors can be converted to the offset distance from the midpoint by multiplying the difference with the sound speed of the medium.

In a three dimensional example, the possible locations for the AE event will be limited to a hyperbola in between the monitoring well and the injection well. In using two wells (injection/monitor), however, even with three component geophones, microseismic events detection can be complicated. In order to improve reliability and efficiency of the conventional method, the present disclosure combines operational improvement (i.e., position and number of the wells) with an advanced signal processing technique.

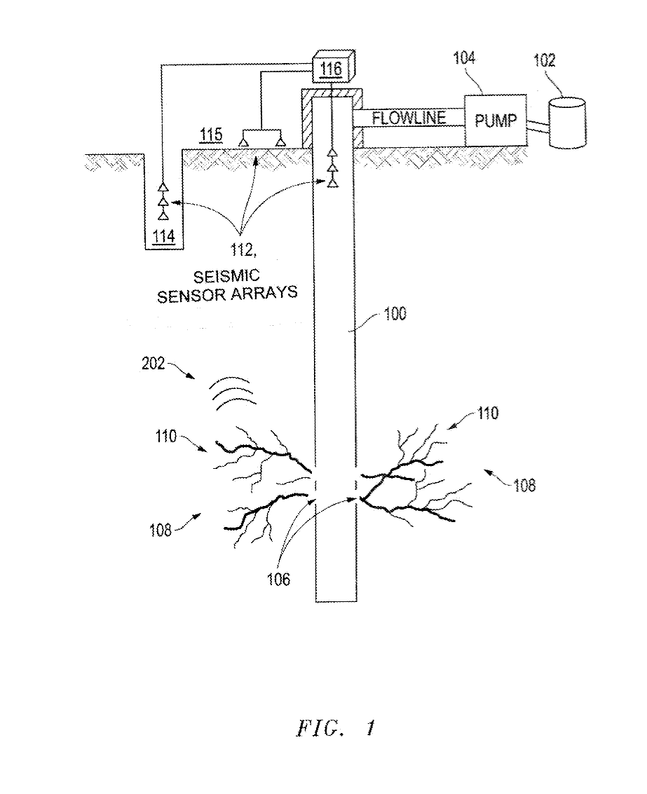

FIG. 1 shows generally an example of a hydraulic fracturing treatment of a borehole (“treatment borehole”) 100. Treatment fluid 102 is pumped into the borehole 100 from a surface reservoir using a pump 104. The treatment fluid 102 may be hydraulically confined to a particular portion of the borehole 100 by using packers. For example, if the borehole 100 includes a completion, then some or all perforations 106 in a particular area may be hydraulically isolated from other portions of the borehole 100 so that the fracturing treatment is performed on a particular portion of the formation 108. In order to implement the treatment, the pressure of the treatment fluid 102 is increased using the pump 104. The communication of the increased pressure to the formation 108 tends to create new fractures and widen or propagate existing fractures (collectively, fractures 110) in the formation 108.

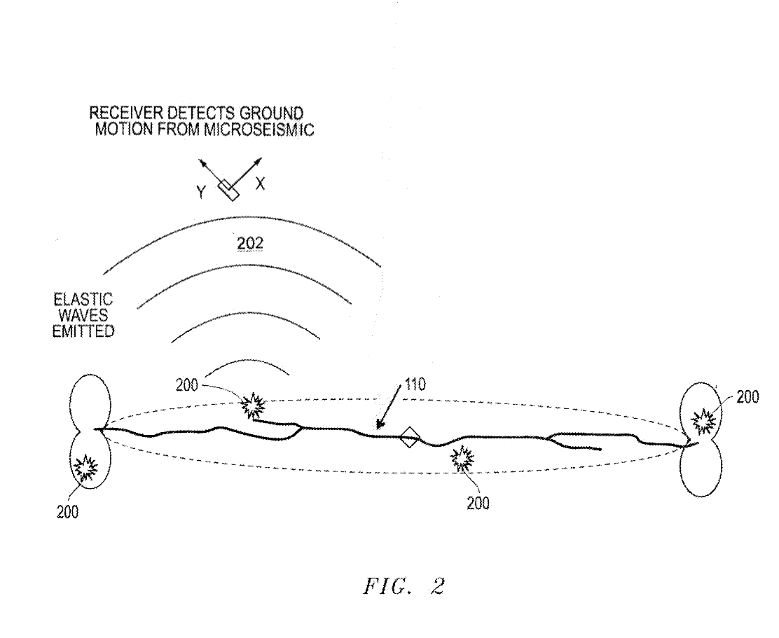

Referring to FIGS. 1 and 2, the hydraulic fracturing treatment described above causes microseismic events 200 to occur. As a result, microseismic waves 202 may be emitted when pre-existing planes of weakness in the formation 108 undergo shear slippage due to changes in stress and pore pressure. The emitted microseismic waves 202 are recorded by arrays of seismic sensors 112 (such as multi-component geophones) disposed in the treatment borehole 100, a monitoring borehole 114, and/or at the surface 115. The microseismic waves 202 detected by the sensors 112 may be processed by a surface analysis device 116 in order to monitor the hydraulic fracturing treatment. For example, the creation, migration and change in fractures may be monitored in terms of both location and volume. The information obtained by monitoring may be used to help control aspects of the fracturing treatment such as pressure changes and fluid composition, and also to determine when to cease the treatment. Further, use of the information to control the treatment may be automated.

In one conventional method of monitoring, seismic events recorded in a single substantially vertical monitoring well can be subject to positional errors because of the time origin of each event is not known a priori, and the formation speed can vary as the acoustic event moves away from the borehole. An inverse problem of locating the origin of each microseismic event can be better constrained if the microseismic event occurs in between two distant detectors in two or more separate wells instead of a single well, and the velocity of the surrounding formation can be measured and established by cross-well survey beforehand. In an embodiment, it can be economical to drill a spiral well in which to dispose detectors rather than a plurality of wells.

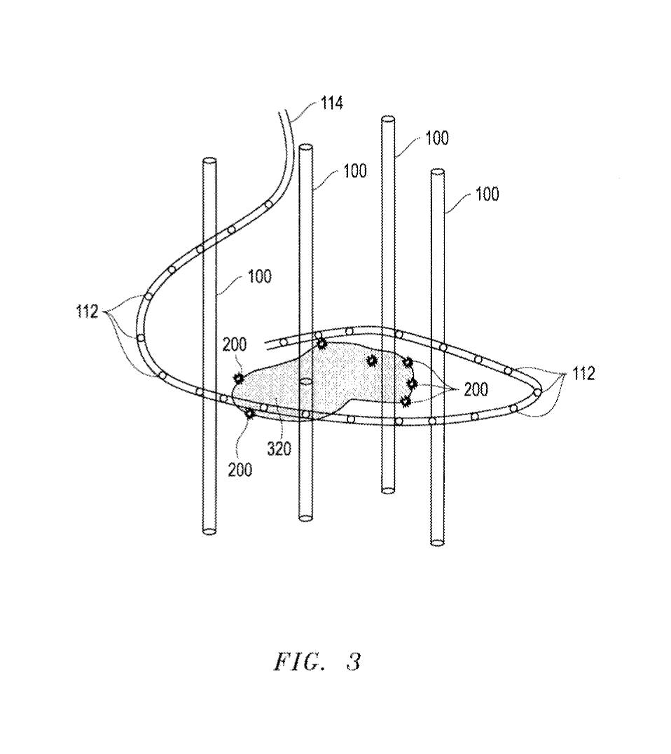

FIG. 3 shows an example wellsite having a spiral monitoring well about four producing wells and an injection well for hydraulic fracture monitoring. The shaded area represents a fractured plane with AE events 200 indicated by the stars. Sensors 112 shown deployed inside the spiral monitoring well 114 surrounding the producing wells 100 can be used to locate the AE events 200 due to fracture propagation. A hydraulic fracturing treatment as described above may be applied in each producing well.

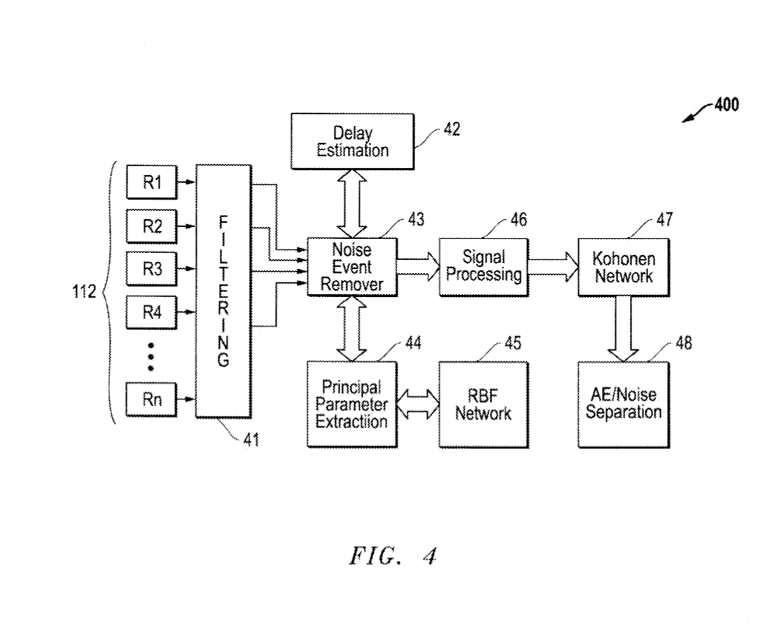

FIG. 4 shows a flowchart 400 of a method for neural network signal processing of microseismic events, which includes filtering and automatically classifying microseismic events with a neural network. The method implements a neural network to cluster potentially fracture-related AE signals and remove noise from actual AE events.

In an embodiment, the method applies a Kohonen neural network, block 47 of FIG. 4 (as described, for example, in T. Kohonen, E. Oja, O. Simula, A. Visa, J. Kangas, Engineering application of the self-organizing map, Proceedings of the IEEE 84 (10) (1996) 1358-1384; and T. Kohonen, Self-Organizing Maps, Springer, New York, 1995) to cluster the potentially fracture-related AE signals and remove noise from actual AE events. Multiple channel signals may be examined to remove low frequency noises (e.g., under or about 100 Hz in general) and events having a ratio of energy in the frequency band of interest to the total energy below a certain threshold, depending on the formation. A radial basis function (RBF) network, block 45 of FIG. 4, can be used to remove high frequency clusters due to, for example, pumping mechanical noises.

The different signals recorded by the receivers R1, R2, . . . RN (where N is the number of sensors) are filtered. Each signal recorded is a combination of the signal of interest with noise of various properties. The first stage includes filtering the recorded signal using an orthogonal wavelet transform, see, e.g., Ten Lectures on Wavelets, Ingrid Daubechies, SIAM: Society for Industrial and Applied Mathematics, 1992.

The algorithm to filter the recorded traces is now described, referring to the block 41 of FIG. 4.

A signal x(t) is defined as a function of time t:

x(t)=f(t)+m(t)

where m(t) represents the noise corrupting the target data f(t), both as a function of time. The purpose of the processing is to filter the data in an automatic manner in order to extract the relevant information. An orthogonal wavelet basis reads:

{2^{-j/2}φ(2^{-j}t−k)}

with (j, k)ε [symbol] ² and φ(t) is the mother wavelet and (j,k) represents the wavelet coefficient at a given scale. The wavelet coefficients of a discrete signal can be computed using a pyramidal algorithm described in Mallat, S., “Multi-resolution approximation and wavelet orthonormal bases of L²(R)”, Trans. Amer. Math. Soc., 315, 69-87, 1989. The wavelet coefficients of a discrete signal can enable substantially simultaneous examination of the information content of the analyzed signal in the time-scale half plane.

If the considered input signal, x(t), has a length of K coefficients, a filtered signal, Sf, will result by performing an inverse wavelet transform with a subset of the initial K wavelet coefficients, thereby automatically detecting the wavelet coefficients that may be used to reconstruct the denoised signal. In the case of white Gaussian noise, a filter criterion may be defined on a probability threshold ρ₀ such as:

$$Sf ≡ prob ( {X}_{n}^{2} \leq \frac{{‖ x - {x}_{f} ‖}^{2}}{{σ}^{2}} )$$

$$where$$

$${‖ x - {x}_{f} ‖}^{2} ≡ {\sum }_{i = 1}^{K} {( {x}_{i} - {x}_{f , , i} )}^{2}$$

where Xₙ² represents the Chi-square probability function with n degrees of freedom. The variance, σ², of the noise may be a priori known. In an embodiment, the variance of the noise can be evaluated directly from the data. In an embodiment, the variance of the noise may be performed by assuming that the recorded information before the first arrival of interest will be representative of the noise. The probability threshold ρ₀ establishes the level of risk that some noise may remain in the filtered signal. From Sf, the coefficients of the signal that will most accurately represent the denoised signal according to the criterion set above is such that

$${‖ x - {x}_{f} ‖}^{2} ≡ {\sum }_{i = 1}^{K - k} {w}_{i}^{2}$$

where wᵢ corresponds to the wavelet coefficients. The sum is performed over the K-k wavelet coefficients discarded to reconstruct x_{F}. The previous condition is achieved if x_{F}(t) is constructed from the k wavelet coefficients with the largest coefficients cf Filtering non-stationary geophysical data with orthogonal wavelets, F. Moreau, D. Gibert. S, Saracco, Geophysical Research Letter, Vol 23, Issue 4, pages 407-410, 1996. When the coefficients are selected, an inverse wavelet transform can reproduce the denoised signal.

After the denoising is applied, a time delay estimation between two different sensors can be computed, as shown in block 42 of FIG. 4. Because potential colored noise can still be present in the data even after denoising is applied as described above, a high order statistic procedure may be used to detect a time delay estimation between two signals even if noise present in the data is colored.

To illustrate the high order statistic procedure, consider two signals, x(t) and y(t), having a delay of τ₀. Noise signals, η(t) and m(t), are not correlated with the source wavelet but can be correlated together. The target data, f(t) and g(t), represent the impulse response of the medium, while s(t) represents the source signal:

x(t)=f(t) [symbol] s(t)+m(t)

y(t)=g(t) [symbol] s(t−τ₀)+η(t)

In order to evaluate the time delay between the two signals, the correlation can involve assuming the nature of the noise. However, the noise can be greater than the target data signal. As such, a bicoherence-correlation approach can be used to evaluate the delay between the two sensors. A bicoherence, BC, can be defined as:

$${BC}_{xyz} ( {ω}_{1} , {ω}_{2} ) = \frac{{bs}_{xyz} ( {ω}_{1} , {ω}_{2} )}{{bs}_{xxx} ( {ω}_{1} , {ω}_{2} )}$$

where ω₁, ω₂ correspond to frequencies
with

$${bs}_{xyz} ( {ω}_{1} , {ω}_{2} ) = \frac{E [ Y ( {ω}_{1} ) X ( {ω}_{2} ) {X}^{*} ( {ω}_{1} + {ω}_{2} ) ]}{\sqrt{{P}_{yy} ( {ω}_{1} ) {P}_{xx} ( {ω}_{1} ) {P}_{xx} ( {ω}_{1} + {ω}_{2}}}$$

where E corresponds to an expectation function, and P, the power spectrum, is defined as:

P_{xy}(ω)=E[X*(ω)Y(ω)]

where X(ω) and Y(ω) represent a Fourier transform of x(t) and y(t) and * represents a complex conjugate.
A bicoherence correlation (BCC) can be defined as:

$${BCC}_{xy} ( {ω}_{1} ) = {TF}^{- 1} [ {\sum }_{{ω}_{2}} {BC}_{xyz} ( {ω}_{1} , {ω}_{2} ) ]$$

where TF⁻¹ corresponds to an inverse Fourier transform. The delay between the two signals will be indicated by the maximum peak of the bicoherence correlation function, see, e.g., Yung, S. K., and Ikelle, L. T., 1997, An example of seismic time picking by third order bicoherence: Geophysics, 62, 1947-1951.

The result of the time delay estimation may be used, in turn, to remove signals that have relatively large absolute differential delay, as shown in block 43 of FIG. 4. An automatic procedure, called Hampel Identifier, may be applied to identify and remove statistical outliers, as follows. A series of peaks detected by P={pₖ} and a median of the series p^{m} can be defined as:

p^{m}=median{pₖ}

where a median absolute deviation (MAD) scale estimator can be computed as:

P_{MAD}=1.4826median{|pₖ−p^{m}|}

The value of median {|pₖ−p^{m}|} is a measure of how far the data point pₖ typically lies from the reference value p^{m}. A normalization factor 1.4826 is based on the fact that a nominal part of the data sequence {pₖ} has a Gaussian distribution. P_{MAD} represents an unbiased estimator of a standard deviation σ when normalized in this manner. A studentized deviations may be calculated as follows:

$${z}_{k} = \frac{{p}_{k} - {p}^{m}}{{P}_{MAD}}$$

In an embodiment, a point may be identified as an “outlier” if |zₖ|>ξ where ξ represents a threshold value. In an example embodiment, ξ may be set to 3, but can be changed without departing from the scope of this disclosure. The procedure can be implemented at a well site with minimal computational resources. Other suitable techniques to detect outliers may be substituted for the procedure described above without departing from the scope of this disclosure.

Turning now to block 44 of FIG. 4, Principal Component Analysis (PCA) can be used for estimating signal subspace from noise or to filter data, however, some PCA methods fail to account for “outliers” when based on least squares estimation techniques. In AE analysis, sometimes part of detected events are related to noise and not to the information of interest. Therefore in order to avoid noise while extracting the principal component of the signal, a “robust” principal component analysis, such as described by Fernando De la Torre, Michael J. Black, “Robust Principal Component Analysis for Computer Vision”, Int. Conf. on Computer Vision (ICCV 2001), Vancouver, Canada, July 2001, can be applied to provide a robust estimation of the target signal subspace.

In principle, the robust PCA estimation involves replacing a standard estimation of the covariance matrix with a robust estimator of the covariance matrix. In order to do so, an expectation maximization algorithm can be used, as described for example, in F. Ruymagaart, “A Robust Principal Component Analysis”, J. Multivariate Anal., Vol. 11, pp. 485-497, 1981; and M. Tipping and C. Bishop, “Probabilistic principal component analysis”, Journal of the Royal Statistical Society B, 61, 611-622, 1999.

In an embodiment, the number of components used to represent the signal subspace may be variable and can vary from one data set to another. In an example for purposes of illustration, the number of components kept to represent the signal subset can be defined as:

$$ɛ = \frac{{\sum }_{i = p}^{q} {λ}_{i}^{2}}{{\sum }_{i = 1}^{r} {λ}_{i}^{2}} ; 1 < p \leq q < r$$

where λᵢ represents the i^{th} eigenvalue of the data matrix, and where p and q are defined by either 1) a plot of the eigenvalues, λᵢ, as a function of i, or 2) a predetermined threshold of the percentage of energy represented in the reconstructed data, and r represents the total number of eigenvalues coming from the covariance matrix computed from the data. This criterion will give the percentage of the energy, which is contained in the reconstructed signal. In block 45 of FIG. 4, a radial basis function (RBF) network can be used to remove remaining noises, see, e.g., Martin D. Buhmann (2003), Radial Basis Functions: Theory and Implementations, Cambridge University, ISBN 0-521-63338-9.

Turning to block 46 of FIG. 4, in practice, some noise may remain after filtering because of various environment conditions, data quality etc. In order to minimize the effect of small amounts of noise remaining, signal processing can be applied on the data prior to feeding the data to a neural network, such as the Kohonen neural network noted above, and represented by block 47 of FIG. 4. Because fracture-related signals do not have the same time-frequency representation as the noise, in an embodiment, the data may be converted in the time-frequency domain during signal processing of block 46 to input into training the Kohonen neural network at block 47 of FIG. 4. Using the time-frequency representation of the signal, the fracture-related signals can be mapped on special neurons to make the target information in the signal more readily identifiable in block 48 of FIG. 4. The time-frequency representation of the data may increase the dimensionality of the information, for the neural network process, as well as for an individual interpreter that will see the data in various domains.

In block 48 of FIG. 4, the neural network is used to classify the various AE signals detected. For microseismic data sets, the data is not represented in a canonical form, i.e., input-output pair, and thus using a supervised neural network method may not be practical. In an embodiment, a Kohonen neural network method is applied because it is an unsupervised method, that is, fully automatic without needing human intervention to work. The neural network is represented based on the input data samples that are grouped into self-similar classes. Training, or sampling the data prior to running the neural network, the neural network (block 47 of FIG. 4) can be performed in one of two manners:

With adequate external information, modeling of previous experiments in similar environments, it is possible to have enough data to train the neural network. The effectiveness of the neural network may be based on the amount of data set used for training. The more used, the better the results will be. In an embodiment, three or more data sets should be sufficient. In an embodiment, a database could contain the data of many measurements and/or experiments previously performed for use in a training phase for neural network processes. In an embodiment, the training of the neural network as well as event classification by the neural network will be performed in the time-frequency domain for the reasons mentioned above.

Without adequate external information, the training phase for the neural network can be more complicated. In this case, one or more sensors can be randomly selected, the measurements from which will be used for training the neural network. In an embodiment, the “training sensors” can be used repeatedly during the training phase for the neural network.

To summarize, noises detected in multiple channels are separated from the events of interest and subsequently removed using a combination of covariance analysis (block 43), principal component analysis (block 44), and differential time delay estimates (block 42). A self-organizing map is then applied in a trained neural network (trained in block 47) to separate the AE's from noise in the remaining data (block 48). At the point in the method in which the number of true AE events have been sorted out from noise, the number of events may be manageable to be processed individually by a person. In an embodiment, an additional neural network, independent from the first, can be used to locate each AE event. For example, the second additional neural network may be of the form used to identify source locations, where numerical simulation data based on known source locations are used to train and optimize the weights used in the neural network.

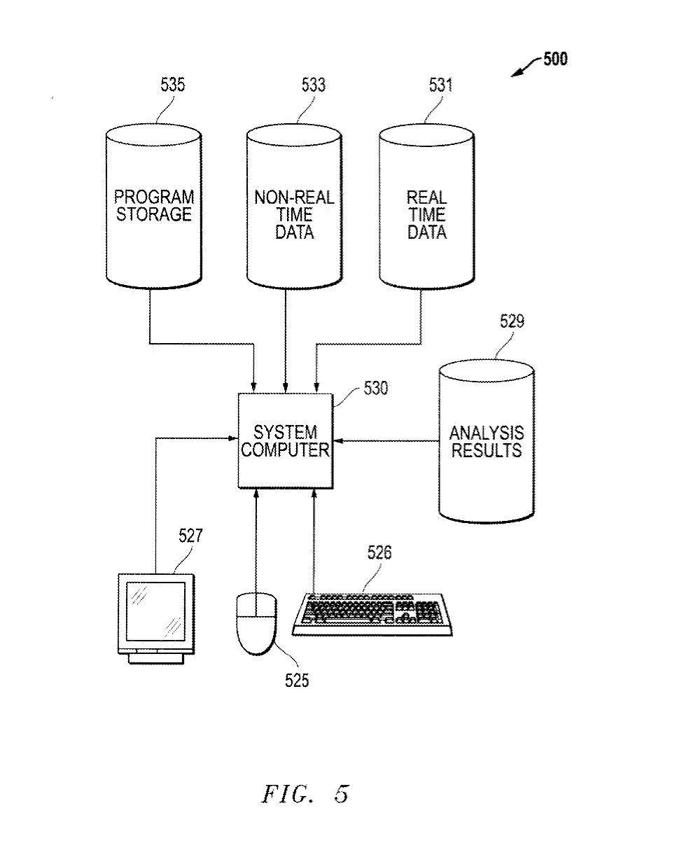

As those skilled in the art will understand, one or more of the steps of methods discussed above may be combined and/or the order of some operations may be changed. Further, some operations in methods may be combined with aspects of other example embodiments disclosed herein, and/or the order of some operations may be changed. The process of measurement, its interpretation and actions taken by operators may be done in an iterative fashion; this concept is applicable to the methods discussed herein. Finally, portions of methods may be performed by any suitable techniques, including on an automated or semi-automated basis on computing system 500 in FIG. 5, which may form, for example, the surface analysis device 116 of FIG. 1.

Portions of methods described above may be implemented in a computer system 500, one of which is shown in FIG. 5. The system computer 530 may be in communication with disk storage devices 529, 531, 533 and 535, which may be external hard disk storage devices and measurement sensors (not shown). It is contemplated that disk storage devices 529, 531, 533 and 535 can be conventional hard disk drives, and as such, may be implemented by way of a local area network or by remote access. While disk storage devices are illustrated as separate devices, a single disk storage device may be used to store any and all of the program instructions, measurement data, and results as desired.

In one implementation, petroleum real-time data from the sensors may be stored in disk storage device 531. Various non-real-time data from different sources may be stored in disk storage device 533. The system computer 530 may retrieve the appropriate data from the disk storage devices 531 or 533 to process data according to program instructions that correspond to implementations of various techniques described herein. The program instructions may be written in a computer programming language, such as C++, Java and the like. The program instructions may be stored in a computer-readable medium, such as program disk storage device 535. Such computer-readable media may include computer storage media. Computer storage media may include volatile and non-volatile, and removable and non-removable media implemented in any suitable method or technology for storage of information, such as computer-readable instructions, data structures, program modules or other data. Computer storage media may further include RAM (Random Access Memory), ROM (Read Only Memory), erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other suitable medium which can be used to store the desired information and which can be accessed by the system computer 530. Combinations of any of the above may also be included within the scope of computer readable media.

In one implementation, the system computer 530 may present output primarily onto graphics display 527, or via a printer (not shown). The output from computer 530 may also be used to control instruments within the steam injection operation. The system computer 530 may store the results of the methods described above on disk storage 529, for later use and further analysis. The keyboard 526 and the pointing device (e.g., a mouse, trackball, or the like) 525 may be provided with the system computer 530 to enable interactive operation.

The system computer 530 may be located on-site near the well or at a data center remote from the field. The system computer 530 may be in communication with equipment on site to receive data of various measurements. Such data, after conventional formatting and other initial processing, may be stored by the system computer 530 as digital data in the disk storage 531 or 533 for subsequent retrieval and processing in the manner described above. While FIG. 5 illustrates the disk storage, e.g., 531 as directly connected to the system computer 530, it is also contemplated that the disk storage device may be accessible through a local area network or by remote access. Furthermore, while disk storage devices 529, 531 are illustrated as separate devices for storing input petroleum data and analysis results, the disk storage devices 529, 531 may be implemented within a single disk drive (either together with or separately from program disk storage device 533), or in any other suitable manner as will be fully understood by one skilled in the art having reference to this specification.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. In the claims, means-plus-function clauses are intended to cover the structures described herein as performing the recited function and not simply structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for neural network signal processing of microseismic events, comprising:
disposing a series of sensors in at least a first well disposed adjacent to a second well;
obtaining a data signal measurement comprising one or more noise events and one or more microseismic acoustic emission events with the series of sensors;
removing the one or more noise events from the data signal measurement; and
determining with a first neural network an arrival time for each microseismic acoustic emission event.

2. The method according to claim 1, wherein removing the one or more noise events comprises: (1) filtering with an orthogonal wavelet transform; (2) computing a time delay estimation; and/or (3) applying a parameter extraction that removes at least one of the one or more noise events as a statistical outlier.

3. The method according to claim 2, wherein removing the one or more noise events further comprises removing one or more noise events by applying a radial basis function network.

4. The method according to claim 1, further comprising converting the data signal measurement into time-frequency domain.

5. The method according to claim 1, further comprising training the first neural network based on one of previously obtained datasets and a subset of the data signal measurement from a selected subset of the series of sensors.

6. The method according to claim 1, further comprising locating each microseismic acoustic emission event with a second neural network.

7. A system for neural network signal processing of microseismic events, comprising:
a series of sensors disposable in at least one first well positioned about a second well disposed in a subterranean formation, the series of sensors being configured to obtain a data signal measurement comprising one or more noise events and one or more microseismic acoustic emission events;
a processor comprising a first neural network, the processor configured to:
remove the one or more noise events from the data signal measurement; and
determine with the first neural network an arrival time for each microseismic acoustic emission event; and
an interface that outputs the arrival time for each microseismic acoustic emission event.

8. The system according to claim 7, wherein the at least one first well comprises a well drilled in a spiral trajectory about the second well.

9. The system according to claim 7, wherein the processor is further configured to at least one of 1) filter the data signal measurement with an orthogonal wavelet transform; 2) compute a time delay estimation based on the one or more noise events and the one or more microseismic acoustic emission events; and 3) apply to the data signal measurement a principal parameter extraction that removes at least one of the one or more noise events as a statistical outlier.

10. The system according to claim 9, wherein the processor is further configured to apply a radial basis function network.

11. The system according to claim 7, further comprising a database populated with data from one of previously obtained datasets and a subset of the data signal measurement from a selected subset of the series of sensors; wherein the processor trains the first neural network based on the data populating the database.

12. The system according to claim 7, wherein the processor further comprises a second neural network configured to locate each microseismic acoustic emission event with the second neural network; and wherein the interface outputs a location for each microseismic acoustic emission event.

13. A computer program product, comprising a computer usable medium having a computer readable program code embodied therein, said computer readable program code adapted to be executed to process microseismic signal events, wherein execution of the computer readable program code by one or more processors of a computer system causes the one or more processors to:
receive a data signal measurement comprising one or more noise events and one or more microseismic acoustic emission events from a series of sensors disposed in a first well, the microseismic acoustic emission events relating to one or more fractures extending from a second well disposed adjacent to the first well;
remove the one or more noise events from the data signal measurement; and
determine with a first neural network an arrival time for each microseismic acoustic emission event.

14. The computer program product of claim 13, wherein execution of the computer readable program code causes the one or more processors to further convert the data signal measurement into time-frequency domain.

15. The computer program product of claim 13, wherein execution of the computer readable program code causes the one or more processors to further train the first neural network based on one of 1) previously obtained datasets and 2) a subset of the data signal measurement from a selected subset of the series of sensors.

16. The computer program product of claim 13, wherein execution of the computer readable program code causes the one or more processors to further locate each microseismic acoustic emission event with a second neural network.
